(19) United States
(12) Patent Application Publication
(10) Pub. No.: US 2026/0213827 A1
(43) Pub. Date: Jul. 23, 2026

(54) METHOD AND APPARATUS FOR BEAM TRACKING

(71) Applicant: Telefonaktiebolaget LM Ericsson (publ), Stockholm (SE)

(72) Inventors: Souta UCHIMURA, Fukuoka (JP); Koji ISHIBASHI, Tokyo (JP); Hiroki IIMORI, Kanagawa (JP); Paulo VALENTE KLAINE, Kanagawa (JP); Szabolcs MALOMSOKY, Kanagawa (JP)

(21) Appl. No.: 19/139,735

(22) PCT Filed: Dec. 20, 2022
(86) PCT No.: PCT/SE2022/051210

§ 371 Date: Jun. 16, 2025

(51) Int. Cl. H04B 7/08; H04B 17/309

(52) U.S. Cl. CPC H04B 7/086; H04B 17/309

(57) ABSTRACT

Techniques for estimating channel parameters of a wireless channel between an AP and UE. A method is performed by a network node configured to control the AP. The method includes acquiring, at a first timeslot, channel parameters from measurements on a first reference signal sent on the wireless channel. The method includes acquiring, at a second timeslot, subsequent and adjacent to the first timeslot, measurements on a second reference signal sent on the wireless channel. The method includes estimating the channel parameters at the second timeslot using sparse signal detection based on the measurements on the second reference signal converted into an angle domain derived from the channel parameters acquired at the first timeslot.

### TECHNICAL FIELD

Embodiments presented herein relate to a method, a network node, a computer program, and a computer program product for estimating channel parameters of a wireless channel between an access point (AP) and a user equipment (UE).

### BACKGROUND

Millimeter wave (mmWave) communications using frequency bands roughly ranging from 24 GHz to 300 GHz is one candidate technique to overcome spectrum shortage problem present at lower frequency bands. However, despite their large available bandwidth, mmWave systems suffer from high propagation loss. Beamforming is therefore used to overcome this impairment. Beamforming involves utilizing antenna arrays with multiple antenna elements to focus the wireless signal in a specific direction. As such, in order to determine in which direction the antenna elements should be combined, it is essential that accurate channel state information (CSI) is available to maximize the beamforming gain. In this context, several channel estimation techniques for mmWave channels have been proposed. However, most such techniques require large training overheads and frequent CSI updates to avoid beam misalignment. This might lead to significant losses in terms of bandwidth efficiency. Therefore, in order to try reducing the required training overhead, while still enabling accurate CSI updates, some other beam tracking techniques have been proposed that exploit the temporal evolution model of the mmWave channel parameters, such as path gain, angle of arrival (AoA), and angle of departure (AoD) of dominant signal paths. Although some beam tracking algorithms assume narrow band channel models, the tracking performance of such algorithms is limited in mmWave systems with large bandwidths due to prohibitive computational complexity. Therefore, beam tracking algorithms for orthogonal frequency-division multiplexing (OFDM) over multiple-input multiple output (MIMO) frequency selective channels have been proposed.

A beam tracking algorithm for wideband mmWave systems based on the generalized marginalized particle filter (GMPF) algorithm was proposed in N. González-Prelcic, H. Xie, J. Palacios and T. Shimizu, “Wideband Channel Tracking and Hybrid Precoding for mmWave MIMO Systems,” in IEEE Transactions on Wireless Communications, vol. 20, no. 4, pp. 2161-2174, April 2021 and later extended in H. Xie, N. González-Prelcic, and T. Shimizu, “Blockage detection and channel tracking in wideband mmWave MIMO systems,” in Proc IEEE Int. Conf. Commun. (ICC), August 2021, pp. 1-6 to a mmWave wireless system that could detect blockage while tracking the beam. In both these disclosures the GMPF method is based on Monte-Carlo estimations. GMPF algorithms achieve high tracking precision at the cost of tremendously high computational complexity, since these algorithms need to test and iteratively evaluate many possible AoA and AoD candidates. Thus, the computational complexity grows with the number of candidates needed to be estimated via GMPF. Considering practical situations, this computational cost hinders real-time processing and results in beam misalignment, especially in high-mobility scenarios.

At least partly, the high computational cost is required by the disclosed algorithms to provide accurate channel estimation. Hence, there is a need for computationally efficient channel estimation.

### SUMMARY

An object of embodiments disclosed herein is to address the above issues.

A particular object of embodiments disclosed herein is to provide computationally efficient channel estimation.

According to a first aspect there is presented a method for estimating channel parameters of a wireless channel between an AP and UE. The method is performed by a network node configured to control the AP. The method comprises acquiring, at a first timeslot, channel parameters from measurements on a first reference signal sent on the wireless channel. The method comprises acquiring, at a second timeslot, subsequent and adjacent to the first timeslot, measurements on a second reference signal sent on the wireless channel. The method comprises estimating the channel parameters at the second timeslot using sparse signal detection based on the measurements on the second reference signal converted into an angle domain derived from the channel parameters acquired at the first timeslot.

According to a second aspect there is presented a network node for estimating channel parameters of a wireless channel between an AP and UE. The network node is configured to control the AP. The network node comprises processing circuitry. The processing circuitry is configured to cause the network node to acquire, at a first timeslot, channel parameters from measurements on a first reference signal sent on the wireless channel. The processing circuitry is configured to cause the network node to acquire, at a second timeslot, subsequent and adjacent to the first timeslot, measurements on a second reference signal sent on the wireless channel. The processing circuitry is configured to cause the network node to estimate the channel parameters at the second timeslot using sparse signal detection based on the measurements on the second reference signal converted into an angle domain derived from the channel parameters acquired at the first timeslot.

According to a third aspect there is presented a computer program for estimating channel parameters of a wireless channel between an AP and a UE. The computer program comprises computer code which, when run on processing circuitry of a network node configured to control the AP, causes the network node to perform actions. One action comprises the network node to acquire, at a first timeslot, channel parameters from measurements on a first reference signal sent on the wireless channel. One action comprises the network node to acquire, at a second timeslot, subsequent and adjacent to the first timeslot, measurements on a second reference signal sent on the wireless channel. One action comprises the network node to estimate the channel parameters at the second timeslot using sparse signal detection based on the measurements on the second reference signal converted into an angle domain derived from the channel parameters acquired at the first timeslot.

According to a fourth aspect there is presented a computer program product comprising a computer program according to the third aspect and a computer readable storage medium on which the computer program is stored. The computer readable storage medium could be a non-transitory computer readable storage medium.

Advantageously, these aspects provide computationally efficient but still accurate channel estimation.

Advantageously, these aspects can be used to convert the above disclosed overly complex Monte-Carlo estimations into a compressed sensing problem based on the channel knowledge at the previous timeslot, thereby reducing the resulting computational complexity.

Advantageously, these aspects take advantage of the temporal evolution of path angles due to, for example, a moving UE, when estimating the channel parameters at the second timeslot.

Advantageously, these aspects provide the same accuracy of the channel estimation as prior art but with lower computational complexity.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIGS. 2, 3, 4, and 7 are flowcharts of methods according to embodiments;

FIG. 5 schematically illustrates a comparison between two sensing matrix constructions according to embodiments;

FIG. 6 provides a graphical representation of a sub-sampling process according to embodiments;

FIGS. 8, 9, and 10 show simulation results according to embodiments;

FIG. 11 is a schematic diagram showing functional units of a network node according to an embodiment;

FIG. 12 is a schematic diagram showing functional modules of a network node according to an embodiment; and

FIG. 13 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

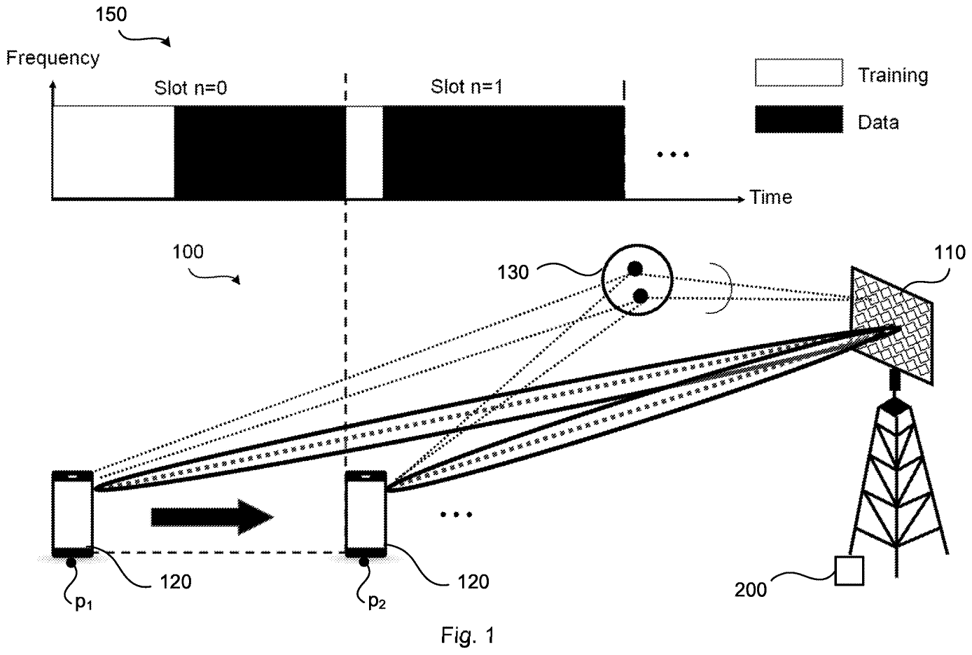

Consider a communication network as in FIG. 1 where MIMO-OFDM uplink communication is used over mmWave channels from a user equipment (UE) 120 towards an access point (AP) 110. The AP is controlled by a network node 200. The communication is performed in timeslots. Each timeslot is divided into a training part and a data part. In the training part, which corresponds to a training phase, the AP and the UE exchange pilot signals for acquisition, or update, of CSI. In the data part, which corresponds to a data transmission phase, a data transmission is performed. Assume that the AP is equipped with a uniform linear array (ULA) with Nₜ antenna elements and receives signals from a UE also equipped with a ULA with Nᵣ antenna elements. Assume further that the UE 120 moves linearly at a constant velocity v such that the UE 120 at a first timeslot is located as position p₁ and that the same UE 120 at a second timeslot is located as position p₂. In addition, the uplink communication is performed in Nₛ data streams.

The mmWave channel between the AP and the UE contains one line-of-sight (LOS) path and several non-line-of sight (NLOS) paths. Each NLOS path might comprise some rays from each cluster of a scatterer. Let c and r denote the index of the cluster and the ray within a cluster, respectively. The mmWave channel at the n-th timeslot, and the d-th delay tap can then be modeled as:

$${H}^{( n )} [ d ] = \frac{1}{μ} {\sum }_{c = 1}^{C} {\sum }_{r = 1}^{{R}_{c}} {α}_{c , r}^{( n )} p ( d {T}_{s} - {τ}_{c}^{( n )} ) {a}_{R} ( {ϕ}_{c , r}^{( n )} ) {a}_{T}^{H} ( {θ}_{c , r}^{( n )} ) \qquad ( 1 )$$

where C, μ, and R_{c} are the number of clusters, paths, and rays within the c-th cluster, respectively. p(⋅) is the equivalent pulse response at the transmitter and receiver calculated from time delay

$${τ}_{c}^{( n )}$$

and sampling duration Tₛ. The complex channel gain at the c-th cluster of the r-th ray is denoted by

$${α}_{c , r}^{( n )} ∼ 𝒞𝒩 ( 0 , {ξ}_{c , r}^{2} ) , where {ξ}_{c , r}^{2}$$

is the path loss component.

$${a}_{R} ( {ϕ}_{c , r}^{( n )} ) ∈ {ℂ}^{{N}_{r} \times 1} , {a}_{T} ( {θ}_{c , r}^{( n )} ) ∈ {ℂ}^{{N}_{t} \times 1}$$

are the ULA response vectors determined by the angle parameters

$${ϕ}_{c , r}^{( n )} and {θ}_{c , r}^{( n )} ,$$

and (⋅)^{H} denotes the transpose conjugate operator. Note that c=1 corresponds to the LOS component and c>1 corresponds to different NLoS paths. Temporal evolutions of the gain, AoA, and AoD of r-th ray of c-th cluster are respectively modeled as:

$${α}_{c , r}^{( n )} = {ρα}_{c , r}^{( n - 1 )} + \sqrt{1 - {ρ}^{2}} {Δα}_{c , r}^{( n )} \qquad ( 2 )$$

$${ϕ}_{c , r}^{( n )} = {ϕ}_{c , r}^{( n - 1 )} + Δ {ϕ}_{c , r}^{( n )} \qquad ( 3 )$$

$${θ}_{c , r}^{( n )} = {θ}_{c , r}^{( n - 1 )} + Δ {θ}_{c , r}^{( n )} \qquad ( 4 )$$

where ρ is the correlation coefficient determined by the subcarrier spacing and velocity v of the UE. The fluctuation term

$${Δα}_{c , r}^{( n )} ∈ ℂ$$

is a circularly symmetric complex Gaussian random variable with zero mean and variance

$${ξ}_{c , r}^{2} \cdot {Δϕ}_{c , r}^{( n )} ∈ ℝ and {Δθ}_{c , r}^{( n )} ∈ ℝ$$

are real random variables followed by any distribution with probability density function (PDF)

$$p ( 0 , {σ}_{v}^{2} )$$

with zero mean and variance

$${σ}_{v}^{2}$$

calculated from velocity v.

It is assumed that these temporal evolutions and probability density functions (PDFs) of fluctuation terms are known in the training process and that the CSI can be updated using this stochastic information. From the relationship between the delay and frequency domains described as a Fourier transform, the mmWave channel at the k-th timeslot can be written as:

$${H}^{( n )} [ k ] = {\sum }_{d = 0}^{D - 1} {H}^{( n )} [ d ] {e}^{- j \frac{2 π k n}{K}} = {A}_{R} ( {ϕ}^{( n )} ) {G}^{( n )} [ k ] {A}_{T}^{H} ( {θ}^{( n )} ) \qquad ( 5 )$$

where D∈ [symbol] , K∈ [symbol] are the total number of delay taps and subcarriers, respectively. The array response matrices are defined as

$${A}_{R} ( {ϕ}^{( n )} ) = [ {a}_{R} ( {ϕ}_{1 , 1}^{( n )} ) , {a}_{R} ( {ϕ}_{2 , 1}^{( n )} ) , … , {a}_{R} ( {ϕ}_{C , {R}_{C}}^{( n )} ) ] ∈ {ℂ}^{{N}_{r} \times μ} and$$

$${A}_{T} ( {θ}^{( n )} ) = [ {a}_{T} ( {θ}_{1 , 1}^{( n )} ) , {a}_{T} ( {θ}_{2 , 1}^{( n )} ) , … , {a}_{T} ( {θ}_{C , {R}_{C}}^{( n )} ) ] ∈ {ℂ}^{{N}_{t} \times μ} .$$

And G⁽ⁿ⁾[k]∈ [symbol] ^{μ×μ} is the diagonal matrix containing complex channel gains.

Let

$${F}_{t}^{( m , n )} ∈ {ℂ}^{{N}_{t} \times {N}_{s}} and {W}_{t}^{( m , n )} ∈ {ℂ}^{{N}_{r} \times {N}_{s}}$$

denote the frequency flat training precoder and combiner designed by the CSI at the previous timeslot, respectively. The received signal at the n-th timeslot, the k-th subcarrier, and the m-th training symbol can be written as (see also below steps S102 and S106):

$${y}_{t}^{( m , n )} [ k ] = {W}_{t}^{{( m , n )}^{H}} {H}^{( n )} [ k ] {F}_{t}^{( m , n )} {s}_{t}^{( m , n )} [ k ] + {z}^{( m , n )} [ k ] where \qquad ( 6 )$$

$${s}_{t}^{( m , n )} [ k ] ∈ {ℂ}^{{N}_{s} \times 1}$$

is a training symbol vector consisting of the frequency dependent QPSK symbol s^{(m,n)}[k]∈ [symbol] multiplied with a frequency-independent reference signal q^{(m,n)}·z^{(m,n)}[k]∈ [symbol] ^{N}^{ₛ}^{×1} denotes additive colored Gaussian noise defined as

$${z}^{( m , n )} [ k ] ∼ 𝒞𝒩 ( 0 , {σ}^{2} {W}_{t}^{{( m , n )}^{H}} {W}_{t}^{( m , n )} ) .$$

The effect of the frequency-dependent symbol can be eliminated by multiplying

$${( {s}^{( m , n )} [ k ] )}^{- 1} by {y}_{t}^{( m , n )} [ k ] .$$

As a result, the received signal after eliminating this effect can be rewritten as:

$${y}^{( m , n )} [ k ] = {y}_{t}^{( m , n )} [ k ] {( {s}_{t}^{( m , n )} [ k ] )}^{- 1} \qquad ( 7 )$$

$${y}^{( m , n )} [ k ] = {W}_{t}^{{( m , n )}^{H}} {H}^{( n )} [ k ] {F}_{t}^{( m , n )} {q}^{( m , n )} + {z}^{( m , n )} [ k ] \qquad ( 8 )$$

$${y}^{( m , n )} [ k ] = ( {q}^{{( m , n )}^{T}} {F}_{t}^{{( m , n )}^{T}} ⊗ {W}_{t}^{{( m , n )}^{H}} ) vec \{ {H}^{( n )} [ k ] \} + {z}^{( m , n )} [ k ] \qquad ( 9 )$$

$${y}^{( m , n )} [ k ] = {Φ}^{( m , n )} Ψ ( {θ}^{( n )} , {ϕ}^{( n )} ) {g}^{( n )} [ k ] + {z}^{( m , n )} [ k ] \qquad ( 10 )$$

$$with the matrix {Φ}^{( m , n )} \hat{=} ( {q}^{{( m , n )}^{T}} {F}_{t}^{{( m , n )}^{T}} ⊗ {W}_{t}^{{( m , n )}^{H}} ) ∈ {ℂ}^{{N}_{s} \times {N}_{t} {N}_{r}} .$$

The array response matrix and channel gain vector are defined as

$$Ψ ( {θ}^{( n )} , {ϕ}^{( n )} ) \hat{=} {A}_{T}^{*} ( {θ}^{( n )} ) ∘ {A}_{R} ( {ϕ}^{( n )} ) ∈ {ℂ}^{{N}_{t} {N}_{r} \times μ}$$

and g⁽ⁿ⁾[k]≙diag{G⁽ⁿ⁾[k]}∈ [symbol] ^{μ×1}, respectively. The operator (⋅)^{T}, ∘, and ⊗ denotes the transpose operation and the Khatri-Rao product and the Kronecker product, respectively. In the training transmission, Mₜ training symbols are sent to the AP. The received signal for all training symbols at the n-th timeslot and k-th subcarrier

$${y}^{( n )} [ k ] = {[ {y}^{{( 1 , n )}^{T}} [ k ] , … , {y}^{{( {M}_{t} , n )}^{T}} [ k ] ]}^{T} ∈ {ℂ}^{{M}_{t} {N}_{s} \times 1}$$

can be written as (see also below step S108):

$${y}^{( n )} [ k ] = {\underbrace{{Φ}^{( n )} Ψ ( {θ}^{( n )} , {ϕ}^{( n )} )}}_{Effective sensing matrix} {g}^{( n )} [ k ] + {z}^{( n )} [ k ] \qquad ( 11 )$$

with the matrix

$${Φ}^{{( n )}_{A}} \hat{=} {[ {Φ}^{{( 1 , n )}^{T}} , … , {Φ}^{{( {M}_{t} , n )}^{T}} ]}^{T} ∈ {ℂ}^{{M}_{t} {N}_{s} \times {N}_{t} {N}_{r}}$$

and the noise vector z⁽ⁿ⁾[k]=[z^{(1,n)}[k], . . . , z^{(M}^{ₜ}^{,n)}[k]]^{T}∈ [symbol] ^{M}^{ₜ}^{N}^{ₛ}^{×1}. Define X⁽ⁿ⁾=[g⁽ⁿ⁾[0], . . . , g⁽ⁿ⁾[K−1]]∈ [symbol] ^{μ×K}, Z⁽ⁿ⁾=[z⁽ⁿ⁾[0], . . . , z⁽ⁿ⁾[K−1]]∈ [symbol] ^{M}^{ₜ}^{N}^{ₛ}^{×K}, and Y⁽ⁿ⁾≙[y⁽ⁿ⁾[0], . . . , y⁽ⁿ⁾[K−1]]∈ [symbol] ^{M}^{ₜ}^{N}^{ₛ}^{×K} to extend y⁽ⁿ⁾[k] for K subcarriers as Y⁽ⁿ⁾=Φ⁽ⁿ⁾Ψ(θ⁽ⁿ⁾,φ⁽ⁿ⁾)X⁽ⁿ⁾+Z⁽ⁿ⁾.

As noted above, there is a need for computationally efficient channel estimation.

The embodiments disclosed herein therefore relate to techniques for estimating channel parameters of a wireless channel between an AP 110 and a UE 120. In order to obtain such techniques, there is provided a network node 200, a method performed by the network node 200, a computer program product comprising code, for example in the form of a computer program, that when run on a network node 200, causes the network node 200 to perform the method.

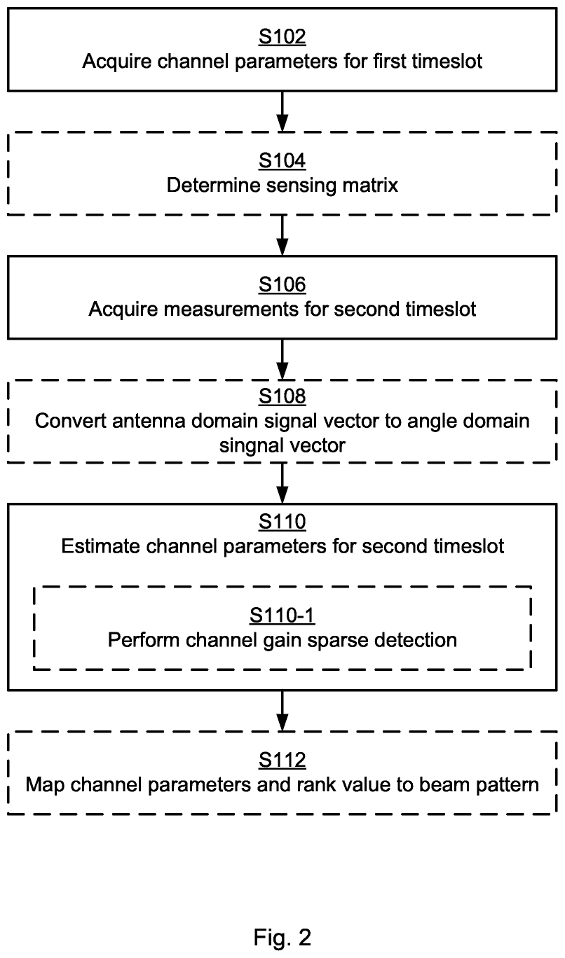

FIG. 2 is a flowchart illustrating embodiments of methods for estimating channel parameters of a wireless channel between an AP 110 and a UE 120. The methods are performed by the network node 200. The network node 200 is configured to control the AP 110. The methods are advantageously provided as computer programs 1320.

It is assumed that the channel parameters at the first timeslot n=0 can be obtained accurately by any decent channel estimation technique based on uplink channel estimation.

S102: The network node 200 acquires, at a first timeslot, channel parameters from measurements on a first reference signal sent on the wireless channel. In this respect, various channel estimation techniques exist that can be used to acquire the channel parameters from the measurements. One non-limiting example is Minimum Mean Squared Error (MMSE) estimation. Another example is MUltiple SIgnal Classification (MUSIC) estimation. Examples of channel parameters will be disclosed below.

In the subsequent timeslots, a tracking method can be performed to update the channel parameters (and beam patterns, etc.).

S106: The network node 200 acquires, at a second timeslot, subsequent and adjacent to the first timeslot, measurements on a second reference signal sent on the wireless channel. The measurements may be made by the network node 200 itself or be provided to the network node 200 from another entity.

S110: The network node 200 estimates the channel parameters at the second timeslot using sparse signal detection based on (or as a function of) the measurements on the second reference signal converted into an angle domain derived from the channel parameters acquired at the first timeslot. In general terms, the angle domain is defined as a signal domain where the variable(s) of interest (i.e., the channel parameters) is/are represented with respect to different angles.

As is understood, steps S106 and S110 (and also below optional steps S104 and S112) can be repeated for yet further timeslots, if needed, for example if the UE 120 has further uplink data to transmit. For example, with information of AoAs, AoDs for the timeslot n=1, a sensing matrix can be generated for timeslot n=2, and so on. This is described in further detail below in the context of sensing matrix determination.

Embodiments relating to further details of estimating channel parameters of a wireless channel between an AP 110 and a UE 120 as performed by the network node 200 will now be disclosed with continued reference to FIG. 2.

There could be different types of reference signals. In some examples, each of the first reference signal and the second reference signal are sent over at least one OFDM subcarrier. For example, the first reference signal might be a downlink reference signal, such as a channel state information reference signal (CSI-RS) or an uplink reference signal, such as a sounding reference signal (SRS). For example, the second reference signal might be a demodulation reference signal (DMRS) sent in either the downlink or in the uplink.

In some embodiments, the channel parameters acquired from measurements on the first reference signal comprise AoA and AoD parameters, and estimating the channel parameters at the second timeslot involves the network node 200 to perform (optional) step S104.

S104: The network node 200 determines a sensing matrix at the first timeslot based on the AoA and AoD parameters. The measurements on the second reference signal are then converted into the angle domain based on the sensing matrix.

In this respect, the sensing matrix comprises matrix of coefficients in the linear representation of the received signal (i.e., measurements), which characterizes how the variable(s) of interest (i.e., channel parameters) is/are represented. In some examples, the sensing matrix is determined by generating discrete AoA and AoD candidates (to formulate a sparse matrix estimation problem). That is, in some embodiments, the sensing matrix is composed of discrete AoA and AoD values that represent channel parameter candidates at the second timeslot.

The measurements on the first reference signal might be represented by an measurement vector with one component for each antenna at which the first reference signal is received. In some examples, the measurement vector is composed of zero entries and non-zero entries, where the non-zero entries correspond to channel gain values, and where each index of the non-zero entries correspond to an AoA and AoD pair. The measurement vector can be converted to the angle domain, as in step S108.

S108: The network node 200 converts the measurement vector to an angle domain signal vector by using the sensing matrix at the first timeslot.

Estimating the channel parameters in step S110 might then comprise step S110-1.

S110-1: The network node 200 performs channel gain sparse signal detection on the angle domain signal vector.

In some embodiments, using the sparse signal detection comprises solving a compressive sensing problem. In general terms, the compressive sensing problem should be solved with an appropriate objective. Such an appropriate objective could be a certain statistical expression of estimation performance, such as a maximum a posteriori estimation, or the like.

In some aspects, only a small portion of the angle domain is sampled. As will be disclosed in further detail below, this could be the case where only a small portion of all possible AoA and AOD candidates are considered based on the AoAs and AoDs information at the previous timeslot. Hence, in some embodiments, during the converting in S108, the angle domain signal vector is formed only from the non-zero entries of the measurement vector.

In some embodiments, performing the channel gain sparse signal detection involves computing an approximated posterior distribution of the angle domain signal vector, and computing maximum a posteriori estimates from the approximated posterior distribution.

In some embodiments, estimating the channel parameters at the second timeslot comprises solving a first optimization problem for estimating AoA and AoD parameters and solving a second optimization problem for estimating channel gain values.

In some aspects the channel parameters (and rank, as estimated from the AoA and AoD) are mapped to a beam pattern. Hence, in some embodiment, the method further comprises step S112.

S112: The network node 200 maps the updated channel parameters to a beam pattern to be applied at the AP 110 for communicating with the UE 120 in the second timeslot. Here, the updated channel parameters are represented by the AoA, AoD and the rank value.

In this respect, for any timeslot n≥1, a beam pattern can be determined based on the channel knowledge at the (n−1)-th timeslot. Although any kind of beam design can be utilized, a frequency flat training precoder and combiner that maximizes the signal to noise ratio (SNR) at the previous timeslot (i.e., the n−1-th timeslot) is assumed hereinafter for illustrative purposes.

After determining the beam pattern based on the channel knowledge at the previous timeslot, the UE transmits uplink data towards the AP. If the UE still has data to transmit, and the CSI needs to be updated, further CSI acquisition and beam tracking as described below can be performed.

There might be further actions taken by the network node 200 that are based on the estimated channel parameters. In some examples, the network node 200 estimates an uplink channel matrix from the channel parameters for uplink data detection at the AP 110 in the second timeslot. In some examples, the network node 200 estimates a downlink channel matrix from the channel parameters for downlink data detection at the UE 120 in the second timeslot. In some examples, the network node 200 estimates the location of the UE 120 in the second timeslot.

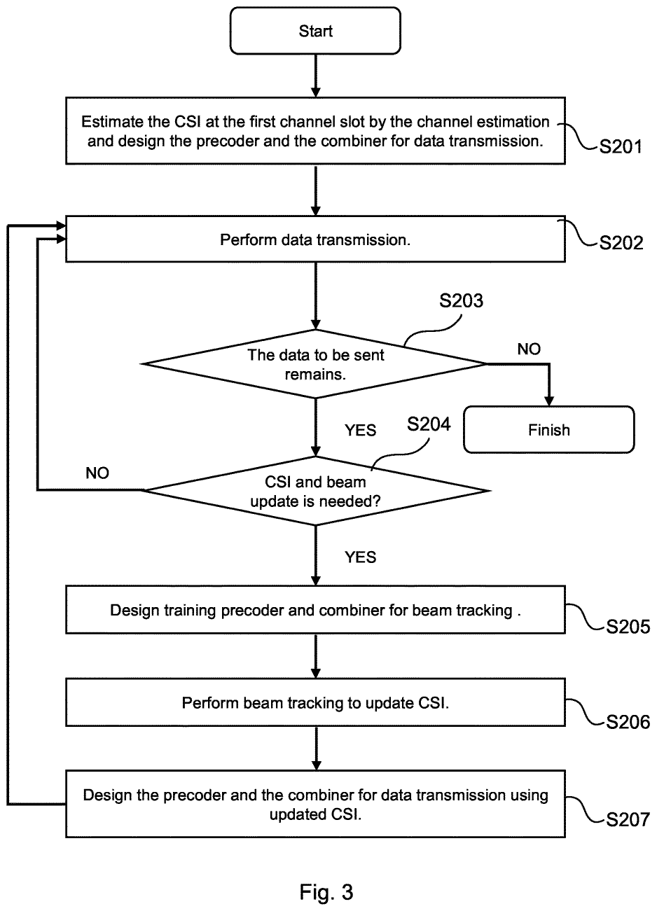

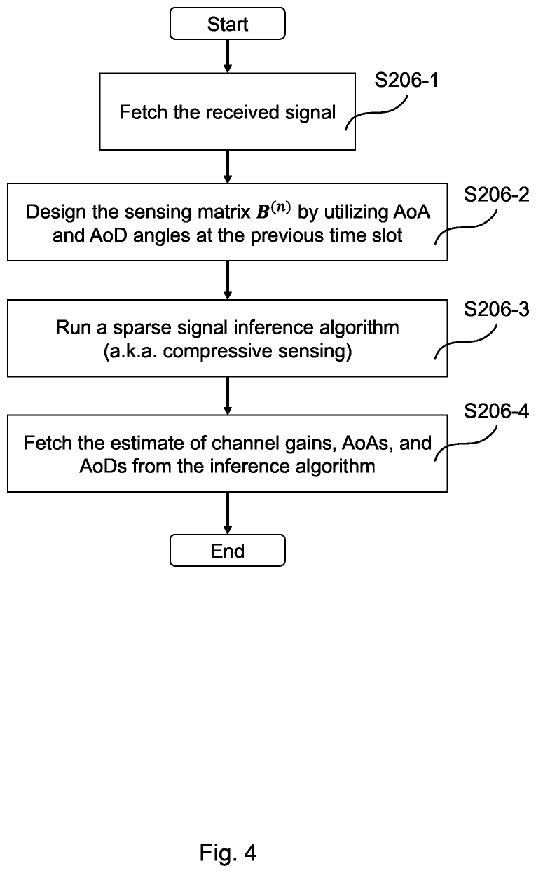

Further embodiments, aspects, and examples as applicable to the herein disclosed methods for estimating channel parameters of a wireless channel between an AP 110 and a UE 120 as performed by the network node 200 will now be disclosed with reference to the flowcharts of FIG. 3 and FIG. 4.

The overall process is outlined in FIG. 3.

S201: The network node 200 estimates channel parameters, for example as represented by CSI, as in step S102. The network node 200 further determines a precoder (representing a beam pattern) and combiner for data transmission.

S202: An uplink data transmission is made by the UE 120 to the AP 110.

S203: It is checked if there is any uplink data left to be transmitted. If yes, step S204 is entered. Else, execution of the method is terminated.

S204: It is checked whether the CSI and the beam pattern needs to be updated for transmission of the data in the subsequent timeslot. If no, step S202 is entered. If yes, step S205 is entered.

S205: The network node 200 updates the precoding matrix and the combining matrix based on the CSI estimate obtained at the previous timeslot. Here, the network node 200 computes the precoding matrix and the combining matrix based on the up-to-date CSI and reports either the precoding or combining matrices to the UE (depending on either uplink or downlink communication is scheduled).

S206: The network node 200 estimates updated channel parameters at the subsequent timeslot. Further details of step S206 are disclosed in FIG. 4.

S207: The network node maps the updated channel parameters, and a rank value as estimated from the updated channel parameters, to a beam pattern to be applied at the AP 110 for communicating with the UE 120 in the further timeslot. Step S202 is then entered again.

Details of step S206 will be disclosed next with reference to FIG. 4.

It is assumed that a signal is received from the UE (as in step S206-1). The signal is a reference signal used by the network node 200 to track the channel parameters.

### Sensing Matrix Determination

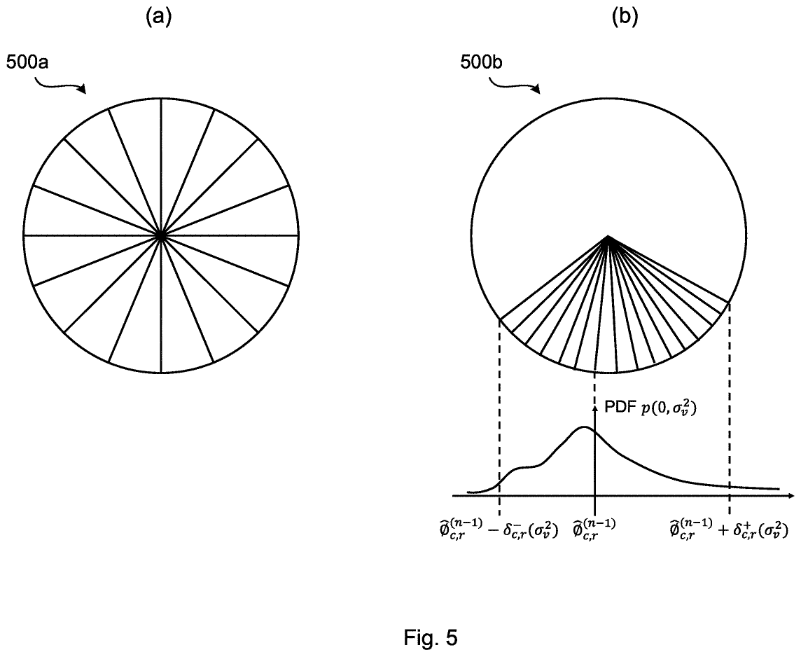

The aforementioned sensing matrix can be determined by generating discrete AoA and AoD candidates to formulate a sparse matrix estimation problem as in equation (11). As for determining the sensing matrix, two approaches 500a, 500b, as shown in FIG. 5, are considered. FIG. 5 shows a comparison between two sensing matrix constructions. In FIG. 5(a) a first approach is shown using a uniform grid from 0 to 360 degrees for AoD and AoA candidates. In FIG. 5(b) a second approach is shown using only a small portion of the whole circle based on the AoAs and AoDs information at the previous timeslot. Sampling a small portion of the angle domain contributes to estimation performance improvements and estimation complexity reduction. According to the first approach 500a, as shown in FIG. 5(a), the angle candidates, for both AoA and AoD, are thus selected according to uniform quantization from 0 to 360 degrees. According to the second approach 500b, as shown in FIG. 5(b), the selection of angle candidates, for both AoA and AoD, is limited to a quantization interval defined by estimates of AoA and AoD at the previous timeslot, and possible some other prior knowledge

The second approach will be described in more detail next. For a given cluster c and ray r, the quantization interval for AoAs

$$[ {ϕ}_{c , r , 0}^{( n )} , {ϕ}_{c , r , {G}_{r}}^{( n )} ]$$

### and AoDs

$$[ {ϕ}_{c , r , o}^{( n )} , {ϕ}_{c , r , {G}_{t}}^{( n )} ]$$

is respectively given by:

$${ϕ}_{c , r , 0}^{( n )} = \text{?} - {δ}_{c , r}^{-} ( {σ}_{A}^{2} )$$

$${ϕ}_{c , r , {G}_{r}}^{( n )} = \text{?} + {δ}_{c , r}^{+} ( {σ}_{A}^{2} )$$

$${ϕ}_{c , r , 0}^{( n )} = \text{?} - {δ}_{c , r}^{+} ( {σ}_{D}^{2} )$$

$${ϕ}_{c , r , {G}_{t}}^{( n )} = \text{?} + {δ}_{c , r}^{+} ( {σ}_{D}^{2} )$$

where [symbol] and [symbol] is the AoA and AoD estimated at the previous timeslot (i.e., n−1-th timeslot), Gᵣ∈ [symbol] Gₜ∈ [symbol] is the number of discrete candidates for AoD and AoA angles, respectively. The angle window sizes

$${δ}_{c , r}^{-} ( {σ}_{D}^{2} ) and {δ}_{c , r}^{+} ( {σ}_{D}^{2} ) , and {δ}_{c , r}^{-} ( {σ}_{A}^{2} ) and {δ}_{c , r}^{+} ( {σ}_{A}^{2} )$$

are calculated from second and/or higher-order statistics (i.e.,

$${Δϕ}_{c , r}^{( n )} and {Δθ}_{c , r}^{( n )}$$

in equation (3) and (4)). With this angle sampling, the grid-angle array response

$$\text{?} = [ {a}_{R} ( {ϕ}_{c , r , 0}^{( n )} ) , ... {a}_{R} ( {ϕ}_{c , r , {G}_{r} - 1}^{( n )} ) ] ∈ {ℂ}^{{N}_{r} \times {G}_{r}} and$$

$$\text{?} = [ {a}_{T} ( {θ}_{c , r , 0}^{( n )} ) , ... {a}_{T} ( {θ}_{c , r , {G}_{t} - 1}^{( n )} ) ] ∈ {ℂ}^{{N}_{t} \times {G}_{t}}$$

are considered with

$${ϕ}_{c , r , {g}_{r}}^{( n )} and {θ}_{c , r , {g}_{t}}^{( n )}$$

being the grid-sample gᵣ={0, . . . , Gᵣ−1} and gₜ={0, . . . , Gₜ−1}.

Collecting the grid-angle array response matrix for all clusters c and rays r, the sensing matrix (as in steps S104, S206-2) can be written as:

$${B}^{( n )} = {Φ}^{( n )} \text{?} ∈ {ℂ}^{{M}_{t} {N}_{s} \times {G}_{t} {G}_{r} \hat{μ}} where$$

$$\text{?} = [ \text{?} , ... , \text{?} ] ∈ {ℂ}^{{N}_{t} {N}_{r} \times {G}_{t} {G}_{r} \hat{μ}} with$$

$$\text{?} = \text{?} ⊗ \text{?} ∈ {ℂ}^{{N}_{t} {N}_{r} \times {G}_{t} {G}_{r}}$$

and \hat{μ} denotes the number of tracking paths that are determined according to the channel estimation phase (i.e., n=0). The operator (⋅)* and ⊗ denotes the complex conjugation and the Kronecker product, respectively.
Transforming into Compressive Sensing Problem

Considering the above, an approximated vectorized channel can be defined as:

$$vec \{ {H}^{( n )} [ k ] \} \approx {B}^{( n )} \text{?} [ k ]$$

where vec(⋅) denotes the vectorization operation.

The received signal can then be approximated in the angle domain (as in step S108) similarly as:

$${y}^{( n )} [ k ] \approx {B}^{( n )} \text{?} [ k ] + {z}^{( n )} [ k ]$$

where [symbol] [k]∈ [symbol] ^{G}^{ₜ}^{G}^{ᵣ}^{\hat{μ}×1} is the sparse vector to be estimated whose non-zero entries correspond to the channel gains and its indexes correspond to the AoAs and AoDs.

The received signal for all subcarriers Y⁽ⁿ⁾=[y⁽ⁿ⁾[0], . . . , y⁽ⁿ⁾[K−1]]∈ [symbol] ^{M}^{ₜ}^{N}^{ₛ}^{×K} can be written as:

$${Y}^{( n )} \approx {B}^{( n )} \text{?} + {Z}^{( n )} where \qquad ( 12 )$$

$$\text{?} {=}^{△} [ \text{?} [ 0 ] , ... , \text{?} [ K - 1 ] ] ∈ {ℂ}^{{G}_{t} {G}_{r} \hat{μ} \times K} .$$

Under the assumption that AoAs and AoDs are constant over subcarriers, the channel gain matrix [symbol] becomes a row sparse matrix. In other words, AoAs and AoDs (but not channel gains) are shared over subcarriers, since the signal between the AP and UE travels through the same scatter points as long as subcarriers span more or less similar frequency bands.

### Performing Compressive Sensing Estimation

The sparse matrix estimation problem can be solved using compressed sensing techniques to estimate channel gain matrix [symbol] with low computational complexity (as in steps S110-1, S206-3).

Different ways to solve the compressed sensing problem, offering performance comparisons in terms of spectrum efficiency and required complexity order, will be disclosed below.

Extracting AoAs, AoDs, and Channel Gains from Sparse Estimates

After retrieving the estimate of the sparse vector, the channel gain(s) can be obtained from dominant elements of the estimate vector. The AoA(s) and AoD(s) can be obtained from the indices of such dominant values of the estimate vector (as in steps S110, S206-4). Given the estimated channel knowledge, the beam pattern can be updated and subsequent data transmission can be performed. This process of updating the beam pattern and performing subsequent data transmission can be repeated until all data has been transmitted from the UE.

Aspects of how to recover the row-sparse matrix [symbol] in equation (12) will be disclosed next.

The objective function for this problem (P-o) can be expressed as follows:

$$( P - 0 ) minimize f ( \text{?} \vert {B}^{( n )} , {Y}^{( n )} )$$

$$subject to {‖ \text{?} ‖}_{2 , 0} = \hat{μ}$$

where ƒ(⋅) is a certain loss function with [symbol] as variables and B⁽ⁿ⁾ and Y⁽ⁿ⁾ as (known) inputs, ∥⋅∥_{2,0} is the l_{2,0} norm that indicates how many rows of a given input matrix are non-zeros. In the context of beam tracking, the number of non-zero rows of [symbol] is assumed to be the same as those at the previous timeslot n>1; therefore, ∥ [symbol] ∥_{2,0} (i.e., the number of non-zero rows of [symbol] ) is enforced to be \hat{μ} (i.e., the number of non-zero rows of [symbol] . With that said, this constraint can also be relaxed to ∥ [symbol] ∥_{2,0}≤μ with μ being an upper bound of the number of tracking paths, which allows estimation of additional path(s) or path blockage(s).

As an example, the objective function ƒ(⋅) can be the Frobenius norm between the estimate and received signal, namely:

$$f ( \text{?} \vert {B}^{( n )} , {Y}^{( n )} ) = {‖ {B}^{( n )} \text{?} - {Y}^{( n )} ‖}_{F}^{2}$$

### Multiple Sub-Sampling Method

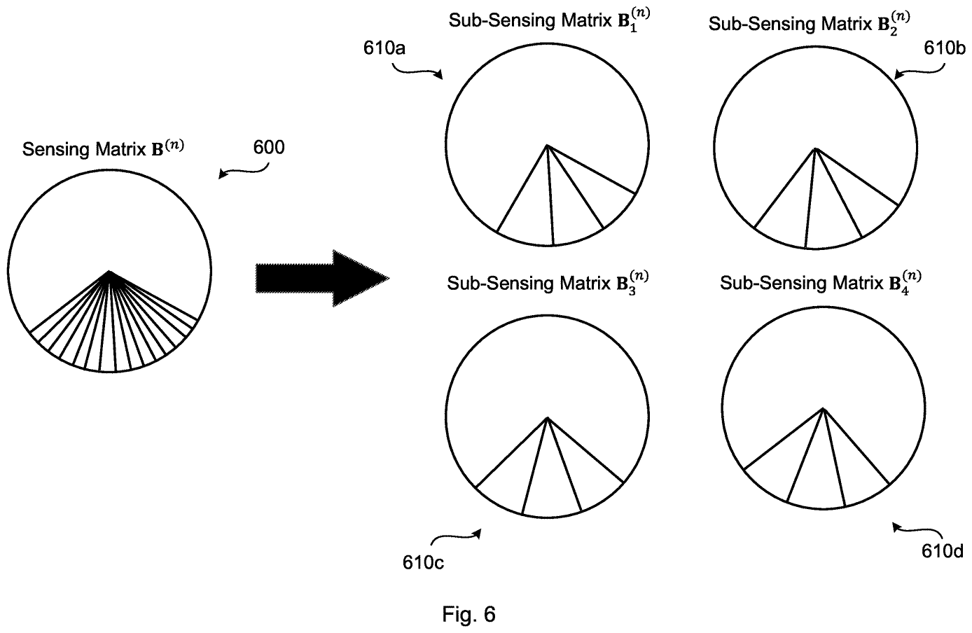

As in equation (12), the grid-based sampling in the angle domain enables conversion of the intractable joint estimation problem of AoAs, AoDs, and gains into a compressed sensing problem. Although the AoAs and AoDs can be estimated more accurately when the grid is finer, this leads to a potential issue in that two discrete angles next to each other in a fine grid might not be distinguished. In order to avoid this issue whilst maintaining the estimation accuracy in AoAs and AoDs, the angle grids can be split into multiple parts. For illustration purposes, in FIG. 6 is provided a graphical representation of the disclosed sub-sampling process that splits a sensing matrix 600 with an angle sector having many grids into multiple sub-sectors, each with a smaller number of grids. AoAs and AoDs candidates can be selected to equally maximize the angular difference between adjacent candidates in all sub-sensing matrices 610a, 610b, 610c, 610d. A large angular difference contributes to the mutual coherence reduction of the sensing matrix.

Each line in the angle sector(s) represents different discrete angle candidate. As illustrated in FIG. 6, after sub-sampling, each sub-sampling grid is more distanced from neighboring grids compared to the original grids at the left-hand side of FIG. 6, which facilitates to distinguish between different discrete angle candidates.

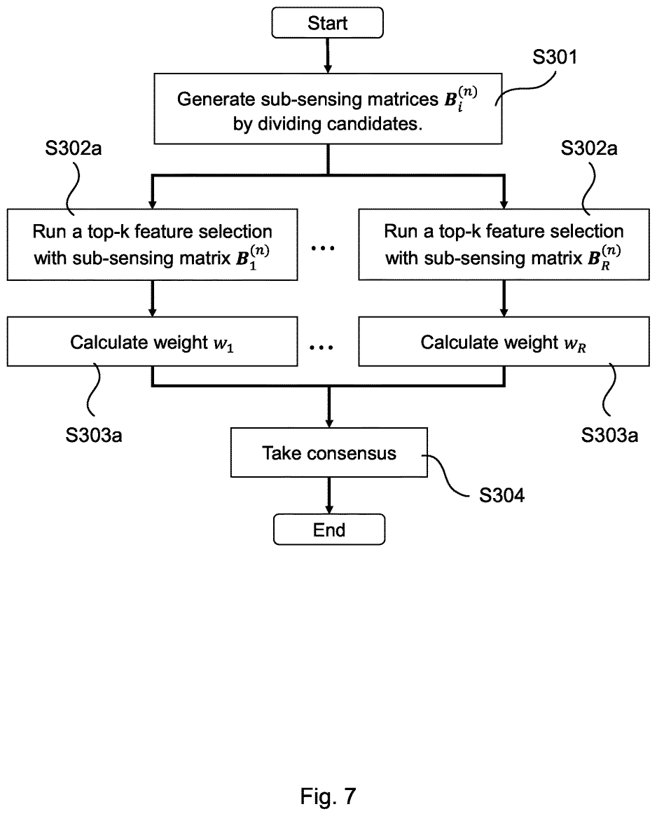

Given the high-level description of the sub-sampling method, when it comes to the mathematical representation, a method as disclosed in FIG. 7 can be used to provide a multiple sub-sensing approach. Instead of B⁽ⁿ⁾ that represents all possible angle candidates (such as the left-hand side of FIG. 6), multiple sub-sensing matrices

$${B}_{u}^{( n )} ,$$

(u=1, 2, . . . , L), each having different angle candidates (i.e., an exclusive subset of all possible angle candidates in B⁽ⁿ⁾) can be considered. Without loss of generality, define Gₜ=Gᵣ=L·l with l being the number of AoAs or AoDs covered by each sub-sensing matrix

$${B}_{u}^{( n )} .$$

It is noted that Gₜ can be different from Gᵣ, but at the sake of simplicity and without loss of generality, it is assumed that Gₜ=Gᵣ. With this, the i-th sub-sensing matrix

$${B}_{u}^{( n )}$$

with l candidates can be defined in step S301 as:

$${B}_{u}^{( n )} = {Φ}^{( n )} \text{?} ∈ {ℂ}^{{M}_{t} {N}_{s} \times {l}^{2} \hat{μ}} where$$

$$\text{?} = [ \text{?} ⊗ \text{?} , ... , \text{?} ⊗ \text{?} ] ∈ {ℂ}^{{N}_{t} {N}_{r} \times {l}^{2} \hat{μ}} with$$

$$\text{?} = [ {a}_{R} ( {ϕ}_{c , r , u - 1}^{( n )} ) , {a}_{R} ( {ϕ}_{c , r , u - 1 + l}^{( n )} ) , ... , {a}_{R} ( {ϕ}_{c , r , u - 1 + ( l - 1 ) l}^{( n )} ) ] ∈ {ℂ}^{{N}_{r} \times l} and$$

$$\text{?} = [ {a}_{T} ( {θ}_{c , r , u - 1}^{( n )} ) , {a}_{T} ( {θ}_{c , r , u - 1 + l}^{( n )} ) , ... , {a}_{T} ( {θ}_{c , r , u - 1 + ( l - 1 ) l}^{( n )} ) ] ∈ {ℂ}^{{N}_{t} \times l} .$$

In view of the above, an optimization problem (P-1) can be formulated for each

$${B}_{u}^{( n )} ,$$

as in steps S302a, S302b. That is:

$$f ( \text{?} \vert {B}_{u}^{( n )} , {Y}^{( 𝔫 )} ) \qquad ( P - 1 )$$

$$subject to {‖ \text{?} ‖}_{2 , 0} = \hat{μ}$$

$$where \text{?} ∈ {ℂ}^{{l}^{2} \hat{μ} \times K}$$

denotes the row sparse channel gain matrix corresponding to the sub-sensing matrix

$${B}_{u}^{( n )} .$$

Each sub-problem gives the estimated AoAs [symbol] AoDs [symbol] ∀c,r and reconstructed channel gain [symbol] ∈ [symbol] ^{\hat{μ}×K}. After collecting the estimates and having computed weights in S303a, S303b, the final estimates can be obtained as a consensus, as in step S304, by taking weighted sum among u=1, 2, . . . , L, namely:

$$\text{?} = {\sum }_{u = 1}^{L} {w}_{u} \text{?} ∀ c , r$$

$$\text{?} = {\sum }_{u = 1}^{L} {w}_{u} \text{?} ∀ c , r$$

$$\text{?} = {\sum }_{u = 1}^{L} {w}_{u} \text{?}$$

where wᵤ∈[0,1] denotes the weight at the estimated values obtained by the u-th sub-problem.

In some examples, the weights wᵤ as calculated in steps S303a, S303b can be determined as wᵤ=1/L. In other examples, the weights can be determined by considering the conditional PDF of AoAs and AoDs given the received signal and optimizing a certain statistical criterion (e.g., maximum a posteriori or softmax).

### A Compressed Sensing Method for Equation (12)

Next will be disclosed how to recover the row sparse matrix [symbol] from equation (12) in a low-complexity manner. In this example, a compressive sensing algorithm is disclosed to address this remaining challenge. First the angles (AoAs and AoDs) are estimated and then the channel gain is estimated.

Aspects of the angle estimation procedure will be disclosed next. Let the Frobenius norm be the objective function and consider the optimization problem (P-1), then the optimization problem (P-2) for finding the angles (AoAs and AoDs) can be written as:

$$minimize {‖ {B}_{u}^{( n )} \text{?} - {Y}^{( n )} ‖}_{F}^{2} \qquad ( P - 2 )$$

$$subject to {‖ \text{?} ‖}_{2 , 0} = \hat{μ}$$

where it is noted that the proposed compressed sensing method can be applied to the problem (P-0) as well.

The problem (P-2) can be solved via the augmented Lagrangian method, which gives the following solution:

$$\text{?} = {( {B}_{u}^{( n )} {B}_{u}^{( n ) H} + {I}_{{l}^{2} \hat{μ}} )}^{- 1} ( E - \frac{1}{β} Λ + {B}_{u}^{( n ) H} {Y}^{( n )} ) \qquad ( 13 )$$

where E∈ [symbol] ^{l}^{²}^{\hat{μ}×K}, Λ∈ [symbol] ^{l}^{²}^{\hat{μ}×K}, and β∈ [symbol] ⁺ denotes the auxiliary variable with the constraint ∥E∥_{2,0}=\hat{μ}, a Lagrange multiplier, and a penalty coefficient, respectively.

The angle estimations correspond to which row(s) are non-zeros. The non-zero row indices can be obtained from equation (13) by taking the \hat{μ} row indices that have the first \hat{μ} largest l₂-norm among the rows of [symbol] . Define by [symbol] the set of estimated non-zero row indices.

After evaluating equation (13) and identifying corresponding non-zero indices, the remaining problem is the channel gain estimation. Since it has already been estimated which row indices become non-zero, a dense matrix [symbol] ≙ [symbol] (G⁽ⁿ⁾) can be considered with [symbol] (⋅) is a mapping function that extracts rows of G⁽ⁿ⁾ corresponding to non-zero row indices [symbol] . Note that [symbol] ∈ [symbol] ^{μ×K}. With this reformulation, the channel gain can be obtained by solving the problem (P-3) given by:

$$\text{?} [ {‖ \text{?} - X ‖}_{F}^{2} ] \qquad ( P - 3 )$$

where the expectation is with respect to the channel gain and the optimization is solved with respect to the variable X∈ [symbol] ^{μ×K}. The problem (P-3) can be solved by the Kalman filter algorithm.

By the steps presented above, the AoAs, AoDs, and channel gains can be efficiently estimated.

### Time Domain Processing

In some aspects, the above expression can be executed in the time domain (instead of the frequency domain, i.e., sub-carriers) by applying the inverse discrete Fourier transform to the received signal matrix in equation (12) and then solving time-domain versions of problems (P-1), (P-2), and (P-3).

### Numerical Results

Some numerical results obtained via simulation will be presented next.

Consider an uplink cellular system with a 100 [m] cell radius operating at ƒ_{c}=60 [GHz] carrier frequency with K=36 subcarriers with W=240 [kHz] subcarrier spacing. The AP, with Nᵣ=32 antenna elements, receives signals from one UE with Nₜ=2 antenna elements, which is moving at v=30 [m/s] and has a P=20 [dBm]transmit power. The path loss is modeled as Urban micro cellular street canyon close-in model. The additive white Gaussian noise (AWGN) variance at the k-th subcarrier is given by

$$10 {log}_{10} ( {σ}^{2} [ k ] ) = 10 {log}_{10} ( 1000 κ T ) + 10 {log}_{10} ( W ) + N F$$

where κ denotes the Boltzmann constant, T=293.15 [K] is the physical temperatures, and NF=5 is the noise figure. It is assumed that the number of clusters is C=3, and each cluster includes R_{c}~ [symbol] [6,10] rays, where [symbol] denotes the discrete uniform distribution. Temporal fluctuations of the AoA

$$Δ {ϕ}_{c , r}^{( n )}$$

### and AoD

$$Δ {θ}_{c , r}^{( n )}$$

are followed by Laplace distribution with 0 mean. In the AoA, the standard deviation of temporal fluctuations is

$$\sqrt{{σ}_{A}^{2}} = 0.57$$

in the LOS path and

$$\sqrt{{σ}_{A}^{2}} = 0$$

in the NLOS paths. At the AoD, the variance of temporal fluctuations is

$$\sqrt{{σ}_{D}^{2}} = 0.57$$

for all paths. These assumptions at the time fluctuations are the same as in the above reference disclosure “Wideband Channel Tracking and Hybrid Precoding for mmWave MIMO Systems”. At the first timeslot n=0, the composed path in each cluster is assumed to be estimated by any channel estimation method. Then, the estimated AoA, AoD, and channel gain in each cluster are respectively given by:

$$\text{?} = {\sum }_{r = 1}^{{R}_{c}} {a}_{c , r}^{( 0 )}$$

$$\text{?} = \frac{1}{{R}_{c}} {\sum }_{r = 1}^{{R}_{c}} {ϕ}_{c , r}^{( 0 )}$$

$$\text{?} = \frac{1}{{R}_{c}} {\sum }_{r = 1}^{{R}_{c}} {θ}_{c , r}^{( 0 )}$$

Thus, the number of tracking paths is \hat{μ}=C=3. The other parameters and precoder and combiner design for both training and data transmission phases are the same as in the above disclosure “Wideband Channel Tracking and Hybrid Precoding for mmWave MIMO Systems”.

In the proposed approach, angle window sizes are

$${δ}_{c , r}^{-} ( {σ}_{A}^{2} ) = {δ}_{c , r}^{+} ( {σ}_{A}^{2} ) = 4 \sqrt{{σ}_{A}^{2}} and$$

$${δ}_{c , r}^{-} ( {σ}_{D}^{2} ) = {δ}_{c , r}^{+} ( {σ}_{D}^{2} ) = 4 \sqrt{{σ}_{D}^{2}} .$$

Also, the proposed approach uses L=4 sub-sensing matrices with l=2 grids.

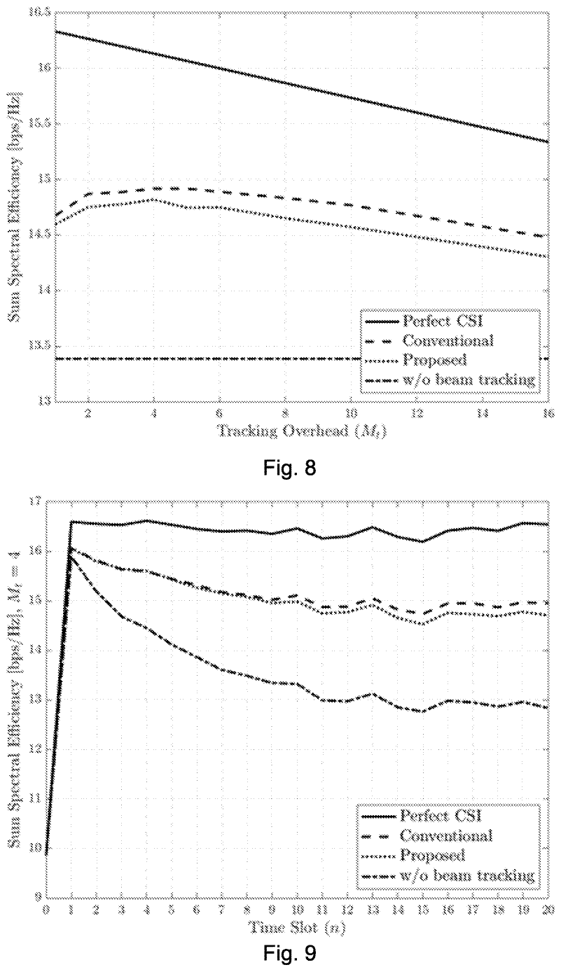

FIG. 8 and FIG. 9 show the sum spectral efficiency over subcarriers defined by:

$$SE {=}^{△} \frac{{M}_{A} - {M}_{t}}{{M}_{A}} {\sum }_{k = 1}^{K - 1} {log}_{2} \vert {I}_{{N}_{s}} + {H}_{e}^{( n )} [ k ] {H}_{e}^{( n ) H} [ k ] {( {σ}^{2} [ k ] {W}^{( n ) H} [ k ] {W}^{( n )} [ k ] )}^{- 1} \vert$$

$$where {H}_{e}^{( n )} [ k ] {=}^{△} {W}^{( n ) H} [ k ] {H}^{( n )} [ k ] {F}^{( n )} [ k ]$$

and M_{A} denotes the total number of OFDM symbols at each timeslot and is assumed to be M_{A}=240. The spectral efficiency plotted in FIG. 8 is the expected value of the sum spectral efficiency over timeslots. The conventional approach uses N_{PF}=50 particles/samples in their Monte-Carlo method. As shown in the figures, the proposed methodologies can provide a comparable SE performance compared with the Monte-Carlo based prior art, significantly outperforming the case where there is no channel tracking capability.

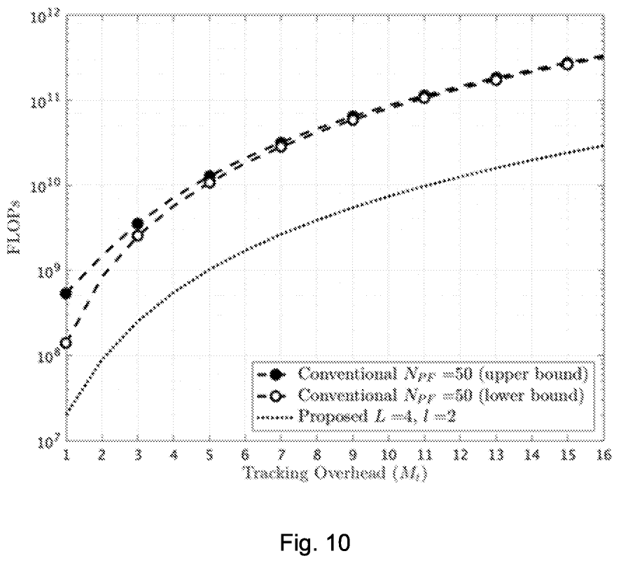

FIG. 10 shows the number of floating operations (FLOPs) required to execute each algorithm, which includes the number of multiplications and additions of each channel tracking algorithm. The FLOPs are not implementation-dependent, since it is the fundamental number of mathematical operations required to run each algorithm, unlike run-time comparison that can vary depending on implementation.

The upper and lower bound means the number of resampled particles in the algorithm presented in the above disclosures “Wideband Channel Tracking and Hybrid Precoding for mmWave MIMO Systems” and “Blockage detection and channel tracking in wideband mmWave MIMO systems”. If only one particle is picked up during the resampling process, the channel gain estimation is only needed once, leading to the lowest complexity in the GMPF. On the other hand, if all particles are picked up, channel gain estimations for all particles are needed. As shown in the figure, the proposed methodology can offer approximately 10 times complexity reduction in terms of FLOPs, while maintaining a similar SE performance as shown in FIG. 8 and FIG. 9.

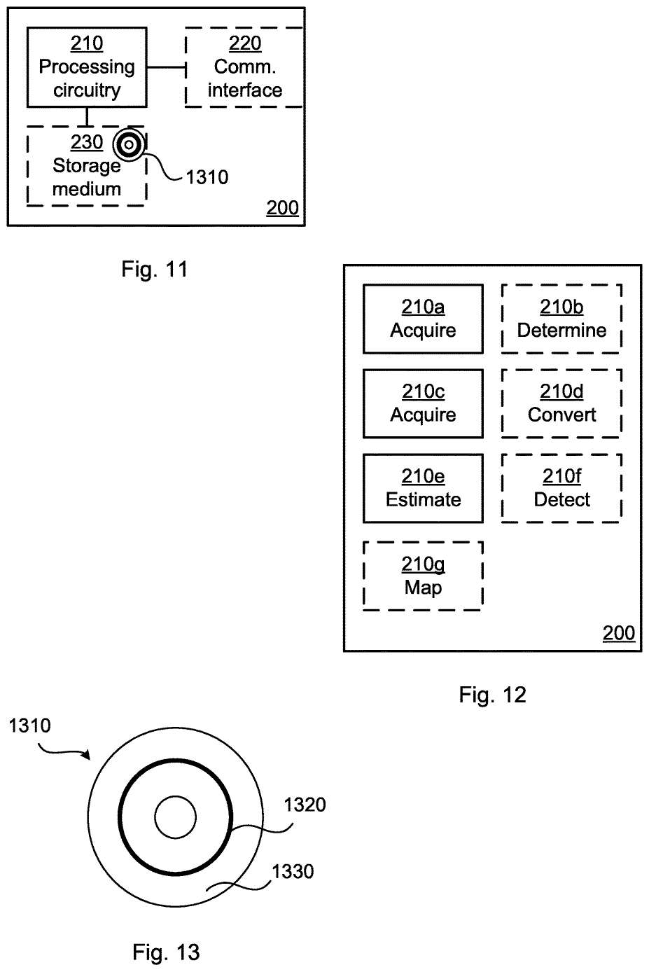

FIG. 11 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1310 (as in FIG. 13), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or steps, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The network node 200 may further comprise a communications (comm.) interface 220 at least configured for communications with other entities, functions, nodes, and devices, as in FIG. 1. As such the communications interface 220 may comprise one or more transmitters and receivers, comprising analogue and digital components. The processing circuitry 210 controls the general operation of the network node 200 e.g. by sending data and control signals to the communications interface 220 and the storage medium 230, by receiving data and reports from the communications interface 220, and by retrieving data and instructions from the storage medium 230. Other components, as well as the related functionality, of the network node 200 are omitted in order not to obscure the concepts presented herein.

FIG. 12 schematically illustrates, in terms of a number of functional modules, the components of a network node 200 according to an embodiment. The network node 200 of FIG. 12 comprises a number of functional modules; a (first) acquire module 210a configured to perform step S102, a (second) acquire module 210c configured to perform step S106, and an estimate module 210e configured to perform step S110. The network node 200 of FIG. 12 may further comprise a number of optional functional modules, such as any of a determine module 210b configured to perform step S104, a convert module 210d configured to perform step S108, a detect module 210f configured to perform step S110-1, and a map module 210g configured to perform step S112.

In general terms, each functional module 210a:210g may in one embodiment be implemented only in hardware and in another embodiment with the help of software, i.e., the latter embodiment having computer program instructions stored on the storage medium 230 which when run on the processing circuitry makes the network node 200 perform the corresponding steps mentioned above in conjunction with FIG. 12. It should also be mentioned that even though the modules correspond to parts of a computer program, they do not need to be separate modules therein, but the way in which they are implemented in software is dependent on the programming language used. Preferably, one or more or all functional modules v may be implemented by the processing circuitry 210, possibly in cooperation with the communications interface 220 and/or the storage medium 230. The processing circuitry 210 may thus be configured to from the storage medium 230 fetch instructions as provided by a functional module 210a:210g and to execute these instructions, thereby performing any steps as disclosed herein.

The network node 200 may be provided as a standalone device or as a part of at least one further device. For example, the network node 200 may be provided in a node of the radio access network or in a node of the core network. Alternatively, functionality of the network node 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the network node 200 may be executed in a first device, and a second portion of the of the instructions performed by the network node 200 may be executed in a second device; the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210 is illustrated in FIG. 11 the processing circuitry 210 may be distributed among a plurality of devices, or nodes. The same applies to the functional modules 210a:210g of FIG. 12 and the computer program 1320 of FIG. 13.

FIG. 13 shows one example of a computer program product 1310 comprising computer readable storage medium 1330. On this computer readable storage medium 1330, a computer program 1320 can be stored, which computer program 1320 can cause the processing circuitry 210 and thereto operatively coupled entities and devices, such as the communications interface 220 and the storage medium 230, to execute methods according to embodiments described herein. The computer program 1320 and/or computer program product 1310 may thus provide means for performing any steps as herein disclosed.

In the example of FIG. 13, the computer program product 1310 is illustrated as an optical disc, such as a CD (compact disc) or a DVD (digital versatile disc) or a Blu-Ray disc. The computer program product 1310 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1320 is here schematically shown as a track on the depicted optical disk, the computer program 1320 can be stored in any way which is suitable at the computer program product 1310.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for estimating channel parameters of a wireless channel between an access point, AP, and a user equipment, UE, the method being performed by a network node configured to control the AP, the method comprising:
acquiring, at a first timeslot, channel parameters from measurements on a first reference signal sent on the wireless channel;
acquiring, at a second timeslot, subsequent and adjacent to the first timeslot, measurements on a second reference signal sent on the wireless channel; and
estimating the channel parameters at the second timeslot using sparse signal detection based on the measurements on the second reference signal converted into an angle domain derived from the channel parameters acquired at the first timeslot.

2. The method according to claim 1, wherein the channel parameters acquired from measurements on the first reference signal comprise Angle of Arrival, AoA, and Angle of Departure, AoD, parameters.

3. The method according to claim 2, wherein estimating the channel parameters at the second timeslot further comprises:
determining a sensing matrix at the first timeslot based on the AoA and AoD parameters, and wherein the measurements on the second reference signal are converted into the angle domain based on the sensing matrix.

4. The method according to claim 3, wherein the sensing matrix is composed of discrete values of the AoA and AoD parameters that represent candidates for the AoA and AoD parameters at the second timeslot.

5. The method according to claim 1, wherein the measurements on the first reference signal are represented by a measurement vector with one component for each antenna at which the first reference signal is received, wherein the measurement vector is composed of zero entries and non-zero entries, wherein the non-zero entries correspond to channel gain values, and wherein each index of the non-zero entries correspond to a pair of one value of the AoA parameters and one value of the AoD parameters.

6. The method according to claim 5, wherein estimating the channel parameters at the second timeslot further comprises determining a sensing matrix at the first timeslot based on the AoA and AoD parameters, and wherein the measurements on the second reference signal are converted into the angle domain based on the sensing matrix, and wherein the method further comprises:
converting the measurement vector to an angle domain signal vector by using the sensing matrix at the first timeslot; and
wherein estimating the channel parameters comprises:
performing sparse signal detection on the angle domain signal vector.

7. The method according to claim 6, wherein, during the converting, the angle domain signal vector is formed only from the non-zero entries of the measurement vector.

8. The method according to claim 6, wherein performing the sparse signal detection involves computing an approximated posterior distribution of the angle domain signal vector, and computing maximum a posteriori estimates from the approximated posterior distribution.

9. The method according to claim 1, wherein using the sparse signal detection comprises solving a compressive sensing problem.

10. The method according to claim 1, wherein estimating the channel parameters at the second timeslot comprises solving a first optimization problem for estimating AoA and AoD parameters and solving a second optimization problem for estimating channel gain values.

11. The method according to claim 1, wherein the method further comprises:
mapping the estimated channel parameters to a beam pattern to be applied at the AP for communicating with the UE in the second timeslot.

12. The method according to claim 1, wherein the method further comprises any, or any combination of:
estimating an uplink channel matrix from the estimated channel parameters for uplink data detection at the AP in the second timeslot;
estimating a downlink channel matrix from the estimated channel parameters for downlink data detection at the UE in the second timeslot;
estimating a location of the UE from the estimated channel parameters.

13. The method according to claim 1, wherein each of the first reference signal and the second reference signal are sent over at least one OFDM subcarrier.

14. A network node for estimating channel parameters of a wireless channel between an access point, AP, and a user equipment, UE, the network node being configured to control the AP and comprising processing circuitry, the processing circuitry being configured to cause the network node to:
acquire, at a first timeslot, channel parameters from measurements on a first reference signal sent on the wireless channel;
acquire, at a second timeslot, subsequent and adjacent to the first timeslot, measurements on a second reference signal sent on the wireless channel; and
estimate the channel parameters at the second timeslot using sparse signal detection based on the measurements on the second reference signal converted into an angle domain derived from the channel parameters acquired at the first timeslot.

15. The network node according to claim 14, wherein the channel parameters acquired from measurements on the first reference signal comprise Angle of Arrival, AoA, and Angle of Departure, AoD, parameters; and
the processing circuitry further is configured to cause the network node to, as part of estimating the channel parameters at the second timeslot, determine a sensing matrix at the first timeslot based on the AoA and AoD parameters, and wherein the measurements on the second reference signal are converted into the angle domain based on the sensing matrix, wherein the sensing matrix is composed of discrete values of the AoA and AoD parameters that represent candidates for the AoA and AoD parameters at the second timeslot.

16. (canceled)

17. (canceled)

18. The network node according to claim 14, wherein the measurements on the first reference signal are represented by a measurement vector with one component for each antenna at which the first reference signal is received, wherein the measurement vector is composed of zero entries and non-zero entries, wherein the non-zero entries correspond to channel gain values, and wherein each index of the non-zero entries correspond to a pair of one value of the AoA parameters and one value of the AoD parameters.

19.-21. (canceled)

22. The network node according to claim 14, wherein using the sparse signal detection comprises solving a compressive sensing problem.

23. The network node according to claim 14, wherein one or both:
estimating the channel parameters at the second timeslot comprises solving a first optimization problem for estimating AoA and AoD parameters and solving a second optimization problem for estimating channel gain values; and
the processing circuitry is further configured to cause the network node to map the updated channel parameters to a beam pattern to be applied at the AP for communicating with the UE in the second timeslot.

24. (canceled)

25. The network node according to claim 14, wherein the processing circuitry further is configured to cause the network node to:
estimate an uplink channel matrix from the channel parameters for uplink data detection at the AP in the second timeslot;
estimate a downlink channel matrix from the channel parameters for downlink data detection at the UE in the second timeslot; and/or
estimate a location of the UE in the second timeslot.

26. (canceled)

27. A computer storage medium storing a computer program for estimating channel parameters of a wireless channel between an access point, AP, and a user equipment, UE, the computer program comprising computer code which, when run on processing circuitry of a network node configured to control the AP, causes the network node to:
acquire, at a first timeslot, channel parameters from measurements on a first reference signal sent on the wireless channel;
acquire, at a second timeslot, subsequent and adjacent to the first timeslot, measurements on a second reference signal sent on the wireless channel; and
estimate the channel parameters at the second timeslot using sparse signal detection based on the measurements on the second reference signal converted into an angle domain derived from the channel parameters acquired at the first timeslot.

28. (canceled)
